(19) United States
(12) Patent Application Publication
(10) Pub. No.: US 2011/0289527 A1
(43) Pub. Date: Nov. 24, 2011

(54) TRANSMISSION METHOD AND DEVICE OF EMERGENT BROADCASTING

(75) Inventor: Fu Wei, Guangdong (CN)

(73) Assignee: ZTE CORPORATION, Shenzhen City, Guangdong (CN)

(21) Appl. No.: 13/124,943

(22) PCT Filed: Jul. 28, 2009
(86) PCT No.: PCT/CN09/00841

§ 371 Date: Apr. 19, 2011

(30) Foreign Application Priority Data
Oct. 21, 2008 (CN) 200810169478.1

(51) Int. Cl. H04N 7/10

(52) U.S. Cl. 725/33

(57) ABSTRACT

A method and a device for transmitting emergency broadcast are disclosed. The method comprises: when a terminal is powered on and a TV application module of the terminal is turned off, the terminal activating an emergency broadcast background module; a tuner sending a multiplexing frame obtained by tuning to the emergency broadcast background module; the emergency broadcast background module analyzing out emergency broadcast information after receiving the multiplexing frame.

### TECHNICAL FIELD

The present invention relates to the field of mobile multimedia broadcast, and in particular, to a transmission method and device for emergency broadcast.

### BACKGROUND OF THE INVENTION

In recent years, digital mobile multimedia broadcast techniques and standards develop very quickly, various standards provide mobile multimedia broadcast terminal users with a plurality of services including advertisement, weather report, news, sports programs, entertainment, multimedia broadcast plays, movies, etc., and the users can select service programs of mobile multimedia broadcast according to their own interests.

Emergency broadcast is a method of informing the public of an emergent event using a broadcast communication system. Emergency broadcast provides a quick and easy way of informing when emergent evens such as natural disaster, accident calamity, public health and social security occur, which causes or may cause serious casualty, property loss, destruction of environment or severe social harms and endanger public security. Emergency broadcast is one of the important applications of mobile multimedia broadcast and is implemented in a form of a broadcast message. After a terminal receives an emergency broadcast message, it displays it to the user in a corresponding displaying manner according to level and type of the emergency broadcast message. Wherein, an emergency broadcast message may be in forms of text, images, audio-video, etc.

A multimedia broadcast signal is transmitted in a way of time division multiplexing in mobile multimedia broadcast technique, and the duration time of the broadcast channel frame is 1 second, which is composed of 40 time slots of 25 milliseconds, wherein one or more time slots can transmit data capsulated in one multiplexing frame. As shown in FIG. 1, in a multiplexing frame structure of mobile multimedia broadcast, the multiplexing frame is divided into three parts: multiplexing frame header, multiplexing frame payload and padding. Mobile multimedia broadcast technique transmits control information and service data separately. As shown in FIG. 2, when the time slots transmit control information, the corresponding multiplexing frame encapsulates control information. As shown in FIG. 3, when time slots transmit service data, the corresponding multiplexing frame encapsulates service data, and the multiplexing frame for encapsulating service data includes one or more multiplexing sub-frames, each of which encapsulates one or more of video segment, audio segment and data segment.

FIG. 4 is a structural flowchart of an emergency broadcast front-end apparatus 400 in the prior art, including an emergency broadcast server 410, a multiplexer 420, a modulator 430 and a transmitter 440 that are sequentially connected with each other. FIG. 5 is a structural flowchart of a TV application module 500 of a terminal in the prior art, including a de-multiplexing unit 510, an emergency broadcast processing unit 520 and an emergency broadcast message displaying unit 530 that are sequentially connected with each other.

FIG. 6 illustrates a transmission method for emergency broadcast in the prior art, which comprises the following steps:

601: an emergency broadcast server 410 constructing an emergency broadcast message (editing text, encoding images or audio-video, etc), configuring an emergency broadcast message level, and transmitting the constructed emergency broadcast message and emergency broadcast message level to the multiplexer 420;

602: after receiving the emergency broadcast message, the multiplexer 420 setting the value of an “emergency broadcast indicator” field in the multiplexing frame header of a multiplexing frame as 1, and encapsulating the emergency broadcast message and emergency broadcast message level into a multiplexing frame 0 following the multiplexing frame, and then transmitting the encapsulated multiplexing frame to the modulator 430, wherein the emergency broadcast message and its level are encapsulated into a control information table of the multiplexing frame 0, and the identifier of the control information table is set as 0×10;

The above multiplexing frame 0 is the multiplexing frame 0 of a next broadcast channel frame following the broadcast channel frame to which the multiplexing frame with the “emergency broadcast indicator” field being 1 belongs.

603: after receiving the encapsulated multiplexing frame, the modulator 430 modulating the received multiplexing frame to a physical channel, and the transmitter 440 transmitting the multiplexing frame into the air through electromagnetic signals;

The transmitter 440 usually transmits emergency broadcast signals in a carousel way (electromagnetic signals of the same emergency broadcast message are repeatedly transmitted continuously). Duration time of carousel is commonly set as about 10 minutes. Duration time of carousel refers to duration time during which the transmitter 440 repeatedly transmits emergency broadcast signals continuously.

604: the terminal receiving the electromagnetic signals transmitted by the transmitter 440, obtaining a multiplexing frame through tuning of a tuner, and transmitting the multiplexing frame to the de-multiplexing unit 510 of the TV application module 500 of the terminal.

605: after receiving the multiplexing frame, the de-multiplexing unit 510 analyzing the multiplexing frame header and judging whether the next broadcast channel frame contains an emergency broadcast message according to the “emergency broadcast indicator” field;

If the value of the “emergency broadcast indicator” field is 1, it means that the next broadcast channel frame contains an emergency broadcast message.

606: if the next broadcast channel frame contains an emergency broadcast message, the de-multiplexing unit 510 obtaining the emergency broadcast message level and emergency broadcast data segments from the multiplexing frame 0 of the received next broadcast channel frame by analyzing, and transmitting them to the emergency broadcast processing unit 520;

607: the emergency broadcast processing unit 520 assembling the received emergency broadcast data segments into an emergency broadcast message, and transmitting the emergency broadcast message and the emergency broadcast message level to the emergency broadcast message displaying unit 530;

608: the emergency broadcast message displaying unit 530 displaying the emergency broadcast message according to the emergency broadcast message level, if the emergency broadcast message level is high-level (level 1 or 2), then compulsively displaying the message; if the emergency broadcast message level is low-level (level 3 or 4), then asking the user whether to display the emergency broadcast message or not, the displaying unit 530 displaying the emergency broadcast message if the user selects “yes”, otherwise, not displaying the message.

The above is a method for implementing emergency broadcast in the prior art. In practical applications, the terminal user usually powdered the terminal off during the time when the terminal is not used so frequently in order to save electrical energy, and in most times, the user does not always use the TV application module 500 even if the terminal is powered on, i.e., the TV application module 500 is in a turned-off condition in most cases. In the case that the TV application module 500 is not activated when the terminal is powered off or powered on, the terminal cannot receive any emergency broadcast message even if there is one, therefore, the purpose of alarming the user cannot be achieved, which may cause a catastrophic result.

### SUMMARY OF THE INVENTION

The technical problem to be solved in the present invention is to provide a method and a device for transmitting emergency broadcast, which ensure that the user can receive the emergency broadcast message in time even in a case that the terminal is powered on while the TV application module is turned off.

In order to solve the above technical problem, the method for transmitting emergency broadcast in accordance with the present invention comprises: when a terminal is powered on and a TV application module of the terminal is turned off, the terminal activating an emergency broadcast background module; a tuner sending a multiplexing frame obtained by tuning to the emergency broadcast background module; and the emergency broadcast background module analyzing out emergency broadcast information after receiving the multiplexing frame.

Further, when a user activates the TV application module, the terminal turns the emergency broadcast background module off, and the tuner transmits the multiplexing frame obtained by tuning to the TV application module; after receiving the multiplexing frame, the TV application module analyzes out the emergency broadcast information.

Further, the terminal periodically turns on and turns off the tuner, and the period is shorter than duration time of carousel of an emergency broadcast transmitter.

Further, when the user presses a power-off key to select to power off the terminal, the terminal setting timer-power-on to power on the terminal through the timer-power on, wherein timing interval of the timer-power-on is shorter than duration time of carousel of an emergency broadcast transmitter.

Further, the emergency broadcast background module judges whether the next broadcasting channel frame contains an emergency broadcast message or not according to the “emergency broadcast indicator” field of multiplexing frame header of the received multiplexing frame, and if the next broadcasting channel frame does not contain an emergency broadcast message, the terminal is informed of setting timer-power-on and the terminal is powered off.

Further, in an emergency broadcast front-end apparatus, a multiplexer separately encapsulates an emergency broadcast message level and an emergency broadcast message such that the emergency broadcast message level is encapsulated in a multiplexing frame header of a multiplexing frame or in a multiplexing sub-frame header of a multiplexing sub-frame of the multiplexing frame and the emergency broadcast message is encapsulated in a control information table of a multiplexing frame 0 of a next broadcasting channel frame of the multiplexing frame.

Further, a de-multiplexing unit of the emergency broadcast background module analyzes the emergency broadcast message level out from the multiplexing frame header of the received multiplexing frame or from the multiplexing sub-frame header of the multiplexing sub-frame of the multiplexing frame.

To solve the above technical problem, the present invention also provides a device for transmitting emergency broadcast, the device comprises a tuner and a TV application module connected with the tuner, and the device further comprises an emergency broadcast background module connected with the tuner; the emergency broadcast background module is used to analyze out an emergency broadcast message from a multiplexing frame received from the tuner when a terminal is powered on and the TV application module is turned off.

Further, the device for transmitting emergency broadcast further comprises an emergency broadcast front-end apparatus, which includes a multiplexer configured for separately encapsulating an emergency broadcast message level and an emergency broadcast message such that the emergency broadcast message level is encapsulated in a multiplexing frame header of a multiplexing frame or in a multiplexing sub-frame header of a multiplexing sub-frame of the multiplexing frame and the emergency broadcast message is encapsulated in a control information table of a multiplexing frame 0 of a next broadcasting channel frame of the multiplexing frame.

Further, the emergency broadcast background module comprises a de-multiplexing unit, the de-multiplexing unit analyzes the emergency broadcast message level out from the multiplexing frame header of the received multiplexing frame or from the multiplexing sub-frame header of the multiplexing sub-frame of the multiplexing frame.

To sum up, in a case that the user terminal is powered on while the TV application module is turned off, the present invention uses an emergency broadcast background module to process an emergency broadcast message as complementation to the TV application module, so as to ensure that the user can receive the emergency broadcast message even if the terminal is powered off, thus ensuring that the user can receive the emergency broadcast message at any time, thereby achieving the purpose of providing emergency broadcast messages for the user in time.

### BRIEF DESCRIPTION OF DRAWINGS

FIG. 1 illustrates the structure of a multiplexing frame header in mobile multimedia broadcast in the prior art;

FIG. 2 illustrates the structure of multiplexing frame payload of multiplexing frame 0 in mobile multimedia broadcast in the prior art;

FIG. 3 illustrates the structure of multiplexing frame payload of a multiplexing frame for encapsulating service data in mobile multimedia broadcast in the prior art;

FIG. 4 is a structural flowchart of an emergency broadcast front-end apparatus in the prior art;

FIG. 5 is a structural flowchart of an emergency broadcast terminal apparatus in the prior art;

FIG. 6 is a processing flow for transmission of emergency broadcast in the prior art;

FIG. 7 is a structural flowchart of a terminal apparatus according to the present invention;

FIG. 8 is a processing flow for emergency broadcast when the terminal is powered on according to the present invention;

FIG. 9 is a processing flow for emergency broadcast when the terminal is powered off according to the present invention.

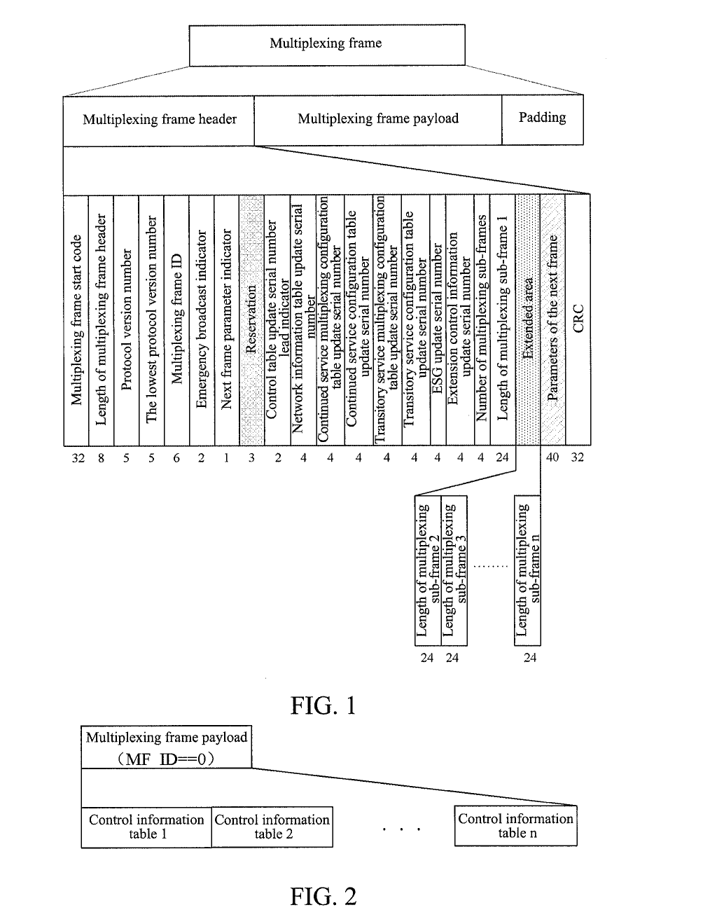

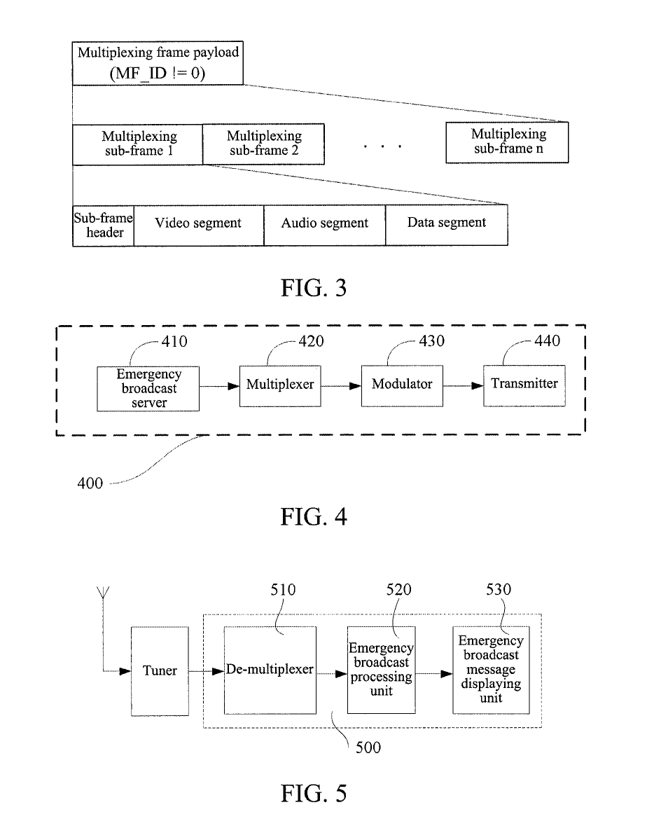

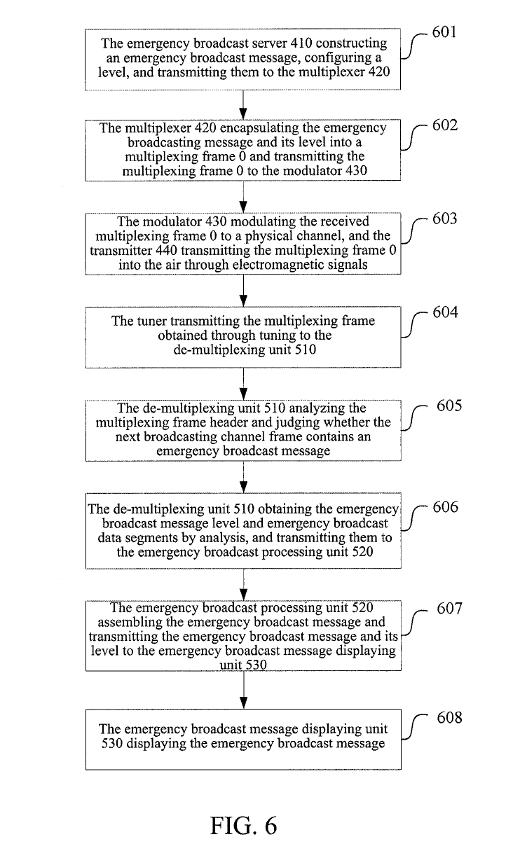

### SPECIFIC EMBODIMENTS OF THE INVENTION

In the present invention, an emergency broadcast background module 700 is added in a terminal for processing an emergency broadcast message when the TV application module of the terminal is turned off, thus achieving the purpose of notifying the user of the emergency broadcast message in time.

The specific embodiments of the present invention will be described below with reference to the accompanying drawings.

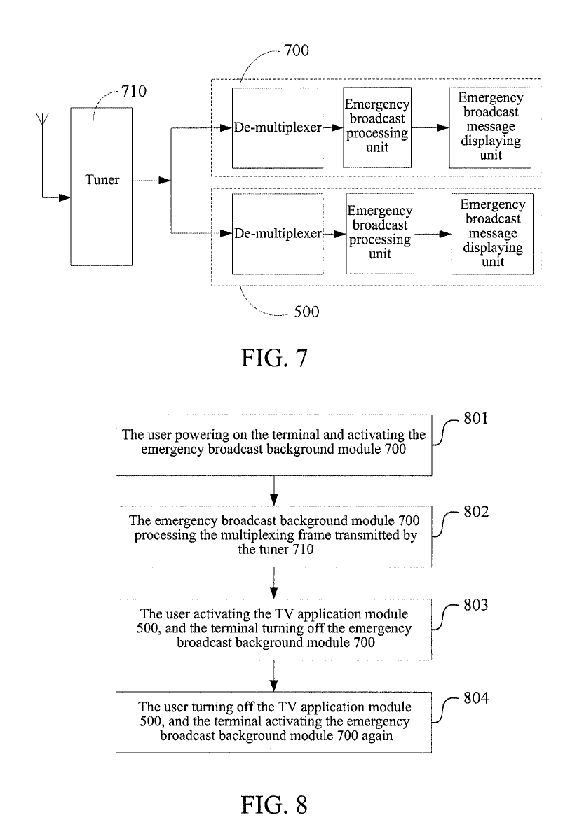

FIG. 7 shows the transmission device for emergency broadcast in the present invention, which comprises: a tuner 710, a TV application module 500 and an emergency broadcast background module 700, wherein the TV application module 500 and emergency broadcast background module 700 are connected with the tuner 710 respectively, and the internal structure of the emergency broadcast background module 700 is the same with that of the TV application module 500, both comprising: a de-multiplexing unit, an emergency broadcast processing unit and an emergency broadcast message displaying unit that are sequentially connected with each other.

The emergency broadcast background module 700 is used to process an emergency broadcast message when the TV application module 500 is turned off. At a certain moment, the terminal only runs one of the emergency broadcast background module 700 and the TV application module 500.

FIG. 8 is a processing flow for emergency broadcast when the terminal is powered on according to the present invention, comprising:

801: after the user powers on the terminal and the terminal completes initialization, activating the emergency broadcast background module 700;

After the terminal is powered on, the TV application module 500 is in a turned-off condition, so the user needs to execute turning-on operation to activate it.

802: the terminal receiving electromagnetic signals and obtaining a multiplexing frame by tuning of the tuner 710, transmitting the multiplexing frame to the emergency broadcast background module 700, and the emergency broadcast background module 700 processing the multiplexing frame (refer to steps 605˜608 for the process of processing);

803: when the user selects to activate the TV application module 500, the terminal turning off the emergency broadcast background module 700, the tuner 710 transmitting the multiplexing frame obtained through tuning to the TV application module 500, and the TV application module 500 processing the multiplexing frame;

804: when the user selects to quit from the TV application module 500, the terminal activating the emergency broadcast background module 700 again, the tuner 710 transmitting the multiplexing frame obtained through tuning to the emergency broadcast background module 700, and then the emergency broadcast background module 700 processing the multiplexing frame;

When the multiplexing frame is processed using the emergency broadcast background module 700, the terminal may periodically turns on and turns off the tuner 710 in order to reduce unnecessary power consumption, and the period should be shorter than the duration time of carousel to ensure that the tuner 710 can receive the emergency broadcast.

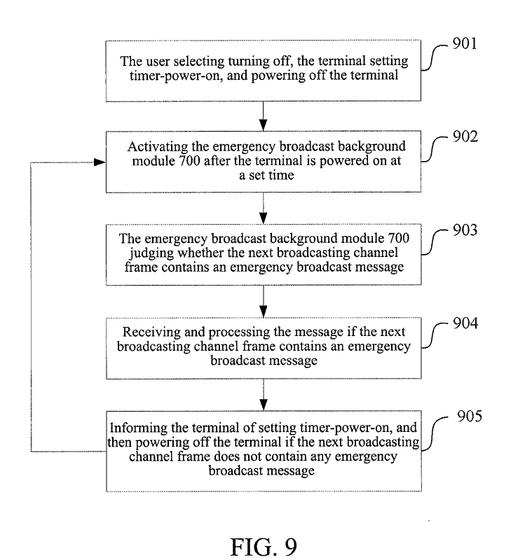

FIG. 9 is a processing flow for emergency broadcast when the terminal is powered off according to the present invention, comprising:

901: when the user presses a turn-off key to select turning off, the terminal sets timer-power-on, and timing interval of the timer-power-on should be shorter than duration time of carousel of a transmitter 440 for transmitting emergency broadcast messages;

Timing interval refers to a time interval from turning off the terminal to turning on the terminal, and timing interval being shorter than duration time of carousel of an emergency broadcast message can ensure that the terminal is powered on during the duration time of carousel of an emergency broadcast message to receive the emergency broadcast message.

902: powering off the terminal, and powering it on when the set time is reached, activating the emergency broadcast background module 700, the tuner 710 transmitting the multiplexing frame obtained through tuning to the emergency broadcast background module 700;

903: the de-multiplexing unit of the emergency broadcast background module 700 analyzing the multiplexing frame, and judging whether the next broadcasting channel frame contains an emergency broadcast message or not according to the “emergency broadcast indicator” field;

904: if the next broadcasting channel frame contains an emergency broadcast message, then receiving and processing the message, end;

905: if the next broadcasting channel frame does not contain any emergency broadcast message, then informing the terminal of setting timer-power-on, wherein the timing interval is shorter than the duration time of carousel of the transmitter 440 for transmitting an emergency broadcast message, skip to step 902.

At present, in the emergency broadcast front-end apparatus 400, the multiplexer 420 encapsulates the emergency broadcast message and the emergency broadcast message level together into the control information table of the multiplexing frame 0, but in order to facilitate processing of the terminal, the emergency broadcast message level and the emergency broadcast message can also be encapsulated separately such that the emergency broadcast message level is encapsulated in a multiplexing frame header or in a multiplexing sub-frame header and the emergency broadcast message is encapsulated in a control information table of a multiplexing frame 0 of a next broadcast channel frame.

The de-multiplexing unit of the TV application module 500 and the emergency broadcast background module 700 directly analyze out the emergency broadcast message level from the multiplexing frame header or the multiplexing sub-frame header and analyze out the emergency broadcast data segments from the multiplexing frame 0 of the next broadcast channel frame.

Of course, the present can also have many other examples, and a person having ordinary skill in the art can make various modifications and changes according to the present invention without departing from the spirit and essence of the present invention, but these corresponding modifications and changes should fall within the protection scope of the attached claims of the present invention.

### INDUSTRIAL APPLICABILITY

In a case that the user terminal is powered on while the TV application module is turned off, the method and device of the present invention use an emergency broadcast background module to process an emergency broadcast message as complementation to the TV application module, so as to ensure that the user can receive the emergency broadcast message. Emergency broadcast can also be received even if the terminal is powered off using the method of the present invention, thus ensuring that the user can receive the emergency broadcast message at any time, thereby achieving the purpose of providing emergency broadcast messages for the user in time.

What we claim is:

1. A method for transmitting emergency broadcast comprising:
when a terminal is powered on and a TV application module of the terminal is turned off, the terminal activating an emergency broadcast background module;
a tuner sending a multiplexing frame obtained by tuning to the emergency broadcast background module; and
the emergency broadcast background module analyzing out emergency broadcast information after receiving the multiplexing frame.

2. The method according to claim 1, further comprising:
when a user activates the TV application module, the terminal turning the emergency broadcast background module off, and the tuner transmitting the multiplexing frame obtained by tuning to the TV application module;
after receiving the multiplexing frame, the TV application module analyzing out the emergency broadcast information.

3. The method according to claim 1, wherein,
the terminal periodically turns on and turns off the tuner, and the period is shorter than duration time of carousel of an emergency broadcast transmitter.

4. The method according to claim 1, further comprising:
when the user powers off the terminal, the terminal setting timer-power-on to power on the terminal through the timer-power-on, wherein timing interval of the timer-power-on is shorter than duration time of carousel of an emergency broadcast transmitter.

5. The method according to claim 4, wherein,
the emergency broadcast background module judges whether the next broadcasting channel frame contains an emergency broadcast message or not according to the “emergency broadcast indicator” field of multiplexing frame header of the received multiplexing frame, and if the next broadcasting channel frame does not contain an emergency broadcast message, the terminal is informed of setting timer-power-on and the terminal is powered off.

6. The method according to claim 1, further comprising:
in an emergency broadcast front-end apparatus, a multiplexer separately encapsulating an emergency broadcast message level and an emergency broadcast message such that the emergency broadcast message level is encapsulated in a multiplexing frame header of a multiplexing frame or in a multiplexing sub-frame header of a multiplexing sub-frame of the multiplexing frame and the emergency broadcast message is encapsulated in a control information table of a multiplexing frame 0 of a next broadcasting channel frame of the multiplexing frame.

7. The method according to claim 6, wherein,
a de-multiplexing unit of the emergency broadcast background module analyzes the emergency broadcast message level out from the multiplexing frame header of the received multiplexing frame or from the multiplexing sub-frame header of the multiplexing sub-frame of the multiplexing frame.

8. A device for transmitting emergency broadcast, comprising: a tuner and a TV application module connected with the tuner, and the device further comprising an emergency broadcast background module connected with the tuner; wherein
the emergency broadcast background module is configured to analyze out an emergency broadcast message from a multiplexing frame received from the tuner when a terminal is powered on and the TV application module is turned off.

9. The device according to claim 8, further comprising:
an emergency broadcast front-end apparatus, which includes a multiplexer configured for separately encapsulating an emergency broadcast message level and an emergency broadcast message such that the emergency broadcast message level is encapsulated in a multiplexing frame header of a multiplexing frame or in a multiplexing sub-frame header of a multiplexing sub-frame of the multiplexing frame and the emergency broadcast message is encapsulated in a control information table of a multiplexing frame 0 of a next broadcasting channel frame of the multiplexing frame.

10. The method according to claim 9, wherein,
the emergency broadcast background module comprises a de-multiplexing unit, the de-multiplexing unit analyzes the emergency broadcast message level out from the multiplexing frame header of the received multiplexing frame or from the multiplexing sub-frame header of the multiplexing sub-frame of the multiplexing frame.
